(19) United States
(12) Patent Application Publication
(10) Pub. No.: US 2007/0266024 A1
(43) Pub. Date: Nov. 15, 2007

(54) Facilitated Search Systems and Methods for Domains

(76) Inventor: Yu Cao, Monterey Park, CA (US)

Correspondence Address: FISH & ASSOCIATES, PC;ROBERT D. FISH, 2603 Main Street, Suite 1050, Irvine, CA, 92614-6232, US

(21) Appl. No.: 11/694,639

(22) Filed: Mar. 30, 2007

Related U.S. Application Data
(60) Provisional application No. 60/800,131, filed on May 11, 2006.
(60) Provisional application No. 60/811,989, filed on Jun. 7, 2006.

(51) Int. Cl. G06F 17/30

(52) U.S. Cl. 707/6

(57) ABSTRACT

A system that enables the search for providers of services or products, for a given user query that's in free text, and typically the services or products are focused on a particular area, such as an industry, a sector, etc. The system thus enables a searcher to submit queries that are substantially similar to those asked to an expert in the area, and get back results that are helpful in their decision making in obtaining services or products. Thus the searcher's experience is substantially similar to that of consulting a human expert. The system employs methods in creating a parameterized database from records such as web pages from the entire Web, with a focus on the area. It also employs methods in segmenting a free-text user query into one or more pieces of information, applying rules to individual pieces as well as their relationship so as to deduct knowledge to be used in search. It also employs methods in performing Proximity Search on records of multi-dimensions for queries of multi-dimensions. Further, it employs methods in matching and placing advertisements in relation to user queries and the concepts contained in these queries. Still further, it employs other various methods to enhance the searcher's effectiveness in their decision making. Finally, the system is aware of a user query's language and region, and serves results, including advertisements, accordingly. The system comprised of automatically discerning the best combinations of a user query's geographical origin and language, retrieving and displaying search results accordingly. A record on the system are associated with a geographic location and a language. A record could be composed of two or more records, each of which associates with a location and a language. A record could be in rich media format.

This application claims priority to U.S. provisional application Ser. No. 60/800131 filed May 11, 2006 and Ser. No. 60/811989 filed Jun. 7, 2006 both of which are incorporated herein by reference in their entirety.

### FIELD OF THE INVENTION

The field of the invention is searching technologies.

### BACKGROUND

Searchers are getting more sophisticated with using search engines and other informational tools on the Web. It is true that “everyone googles”, but it is also true that no one types his itinerary to Google's™ search box and expects to get back a list of flights and prices—he knows Expedia does that kind of work and Google does not. On the other hand, if the searcher knows the name of a company and wants to find out its web site, as in searching for “American Airlines” and expecting to get its web address (happens to be www.AA.com), Google, along with other general web search engines, serves well this particular search need.

The distinctions between the use of Google and that of Expedia teach the following essential characteristics of an online information tool: (1) each has a different database. With a general web search engine, the database is web pages from the entire Web, and for Expedia, which we call an intermediary engine, the database is a product catalogue focused on flights, hotel and car rentals; (2) each takes in different kinds of user input. For general web search engine, it is free-text query, typically of a few words; and for intermediary engines, it is a form of multiple fields, each of which is to be filled by the searcher; (3) each has its own matching mechanism. For general web search engine, it is essentially exact matching between query words and words in web pages, with the preferred embodiment of proximity search. For intermediary engines, it is exact matching between values of fields in user input and those of fields in the database of a product catalogue.

Each tool serves different search needs of a searcher. When a searcher can formulate his search need in a few words, and want to find web pages contain exactly these words, general web search engines serve well. When a searcher can formulate his search need in a few pairs of attribute and value, and an intermediary engine contains catalogues of exactly the kind of products the searcher is looking for, then the engine will serve well.

All other information tools can be modeled with above-mentioned three characteristics. We enumerate below. (1) Home values, such as Zillow.com. A typical input is an address, or a street; expected results are home values; the engine's database is a catalogue of values of home at different addresses; (2) Bulletin board such as eBay.com. A typical input is keywords; expected results are items for sale; and the engine's database is forms filled out by sellers; (3) Business directories, such as Business.com. A typical input is keywords; expected results are company information; the engine's database is forms filled out by companies; (4) B2B search engines, such as Alibaba.com and GlobalSpec.com. A typical input is either keywords, or filled out forms; expected results are product specifications and their manufacturers; the engine's data is product catalogues of certain classes of products; (5) Comparison shopping sites, such as NexTag.com, which is similar to Expedia in terms of input, results and database; (6) local search engines, such as CitySearch.com, and Google's local.google.com, which is yet another variation of intermediary engines. A typical input are of two fields, one for the name of a business, or the category of a business, as in “Chinese restaurants”, and the other field for a location, as in a city or a zip code; the expected results are a list of businesses, their contact information, and some times a short description of their services; and the engine's database is essentially yellow pages information.

The currently available online information tools, while each serves well for the purpose it is built, leave a large white space of un-served search needs. Consider, for example, the situation of a searcher in the area of real estate. She is hunting for an apartment or a house, for a temporary relocation of 12 months. If she wants to use a corporate housing company, then querying “Oakwood corporate housing” or such on Google might well satisfy her search need. If, however, she wants to rent from other parties, and knows the city well enough, searching through Apartments.com's catalogue might suffice. However, if she poses her search need as a natural language query, such as “family of two kids, one dog, looking for an apartment or a house, close to West Los Angeles, with good schools, one year lease”, then no available online tools can return helpful results to her.

For a searcher who is interested in finding information in an area, such as an industry or a specific sector of an industry, a general web search engine is wanting. Among other things, the search engine would typically search against a set of all the web pages that it can crawl from the entire Internet, and these pages number close to 10 billion as of this writing. That is an enormous number given that there are probably less than 10 million relevant pages. This phenomenon in turn leads to the observed situation where returned results for a given query include records that are entirely or largely irrelevant to the area of the searcher's interest.

One way of improving the situation is for the web search engine to partition its database into hundreds or even thousands of areas. The searcher is asked to pick one or more areas when conducting a search, and the engine searches for results only from the area or areas picked by the searcher.

Globalization necessitates an audience of diverse languages and geographic locations. To satisfy a user's information need, relevance is necessarily a function of both language and location.

Consider a company whose potential clients are in different countries and regions, speaking difference languages. The company's web site contains pages that are relevant for different clients. For example, one page aims at potential English-speaking clients from Los Angeles (“our sales office is a sort distance from the Union Station . . . ”); another page aims at potential clients from Los Angeles speaking Spanish; still another page at clients from Los Angeles speaking Chinese; and still another page at clients from Shanghai speaking Chinese (a Chinese equivalent of the following message “Our Shanghai office handles businesses throughout the Eastern China”).

Now suppose all these web pages are searchable through a search engine.

A user query submitted to the search engine might originate from any part of the world, and the user composes the query in a language of her choice. If the search engine can automatically discern the origin, and the language, of the query, then the engine can match information in the most appropriate combination of location and language, and display accordingly. For example, a barber shop's information is typically relevant only to a user from the same or neighboring zip codes, a CPA from the same or neighboring cities, and a software developer maybe the same country, all preferentially speaking the same language as a potential client.

In searching, the state of the art is to use information contained in user's browser and the user query to detect the country (in prior art FIG. 4, for example), or the geographic location (in prior art FIG. 5, for example), or the preferred language (in prior art FIG. 3, for example). There is also prior art that uses information provided by user's browser to determine both the country and the language (in prior art FIG. 2, for example).

The state of the art is not satisfactory. For one reason, geographic locations are of different “granularities” arranged in a hierarchical manner. It decidedly enhances relevance if the smallest possible granularity (many times much finer than “country”) is discerned, and used in searching. For example, the zip code 90024 corresponds to an area within the district of West Los Angeles, which in turn is within the city of Los Angeles, which in turn is part of the Greater Los Angeles, Southern California, California, America's West Coast, the United States of America, and North America. When the zip code 90024 is detected, search results associated with the zip code might be the most relevant, those associated with the district are less relevant, and in a decreasing order of relevance those associated with the city, the region, so on.

The state of the art is not satisfactory, for another reason, that sometimes there could be multiple detected locations. Further, sometimes there could be multiple detected languages. The state of the art uses only one pair of location and language, if that.

Further, the recent explosion of online videos for consumers, exemplified by contents on and visits to YouTube.com, leads to the contention that an explosion of online video for businesses is in the offing. Continuing the example above, suppose the company's web site features “About Us” videos that are dubbed in different languages aiming at different geographic locations. The need for a search engine to consider the best combinations of location and language is even more pronounced.

An observation from the example above is that many times a same piece of information exists in different languages for audiences in different locations, which calls for a means to identifying such relationships among records. Current state of the art does not speak to this.

The discussion above applies to records that comprise of Web pages, documents, catalogues, and advertisements.

This and all other extraneous materials discussed herein are incorporated by reference in their entirety. Where a definition or use of a term in an incorporated reference is inconsistent or contrary to the definition of that term provided herein, the definition of that term provider herein applies and the definition of that term in the reference does not apply.

What is still needed is methods that automatically discern geographic locations of the smallest possible granularity, determine the language or the languages of the user query, and evaluate the applicability of the geographic locations using at least the language or the languages. Once locations and languages are determined, best combinations of locations and language help retrieve and display records.

### SUMMARY OF THE INVENTION

This application pulls together several different concepts, each of which is but a part of the inventive subject matter. Among other things, that subject matter provides systems and methods in which an online information tool has one or more of the following characteristics: (1) automatically creating a parameterized database from records such as web pages from the entire Web, as well as from other sources, with a focus on a given area, such as an industry, a sector. The resultant database approaches in structure to databases of product catalogues; (2) taking in user queries that are free text, just like queries to web search engine's, but segments a query into one or more pieces of information, not unlike a filled out form used by intermediary engines; (3) employing matching methods that combines matching on multiple fields, which is not unlike a database search, with proximity search, which is used only by web search engines; and (4) applying knowledge from the given area, to each of the above.

The overall system is what we call “searching parameterized data using natural language queries”. It is a system that enables the search for providers of services or products, for a user query that's written in free text, and typically the services or products are focused on a particular area, such as an industry, a sector, etc. The typical user query expresses one or more terms whose meaning and relationship has an area focus, thus it is more complex than a typical keyword search query submitted to web search engines. The system thus enables the searcher to submit queries that are substantially similar to those asked to an expert in the area, and gets back results that are helpful in their decision making.

We employ the following methods in automatically creating a parameterized database from records such as web pages, with a focus on a given area, such as an industry, a sector:
With “iterative dual expansion for creating datasets of both high precision and high recall”, the system employs methods that start with two readily available input datasets, and outputs a dataset of desirable properties. Typically desirable properties are relevance to a given area, such as an industry, a sector. The first input dataset comprises a large number of records, typically web pages from the entire Web; the second comprises a small number, easily obtained records, typically web pages, all of which have the desired properties. The methods copy the second input dataset into the output dataset, and expand the output dataset by taking records from the first input records that are measured as having the desirable properties, and the measured is computed initially from information available from the first input dataset, and progressively from information from both the first input dataset as well as the output dataset. The iterations stop when certain threshold, mainly based on the desirable properties of all records in the output dataset, is met.
With “creating parameterized data from web records”, the system employs methods that turn input records such as web pages into parameterized records which are associated with entities such as a company. First, input records are associated with entities such as companies. Within the context of an area such as an industry, a sector, an entity belongs to one or more types, and all types are arranged hierarchically into a “type hierarchy” which has been provided. For each type, a hierarchy of fields has been provided. By mechanisms such as applying keyword lists, a company is determined to be of certain types to the deepest possible levels on the type hierarchy. Then by mechanisms such as applying keyword lists, information is extracted piece by piece, from the records associated with them company, and each piece of information is associated with a field.

We employ the following methods to turn a free-text user query into something unlike a filled out form:
With “segmentation of and deduction from natural language queries”, the system employs methods that recognize one or more pieces of information of a free-text user query, and deduct knowledge from individual pieces, as well as the relationship among multiple pieces. Each piece of information belongs to a certain type. Rules are applied to each piece so that knowledge is deducted, typically within the context of an area, which could be an industry, a sector. When there are multiple pieces of information, further rules are applied to the relationship among the pieces of information. The recognized pieces of information, the unrecognized portion of the user query, and the deducted knowledge, are used in search.

We employ the following methods to perform matching that combines proximity search and database search:
With “multi-dimensional Proximity Search for matching and ranking”, the system employs methods that perform proximity search on multiple dimensions. The information about an entity, such as a company, typically is of multiple pieces, and thus best expressed by multiple attribute-value pairs. Attributes can further be iteratively grouped, resulting in a multi-dimensional structure that's best expressed as a tree. To retrieve such entities, a query can be similarly of multi-dimensional. The matching between a query and an entity thus is necessarily multi-dimensional. In the context of Information Retrieval, proximity search has been known to perform on one-dimension, and is a key enabler of current web technology. Our methods performs proximity search on multi-dimensions, and returns best matching entities for a query. Further, our methods also apply to calculating the similarity between two entities.

We augment various aspects of the search results with following methods, so that to increase the searcher's effectiveness in satisfying his search need.

We provide a language- and region-specific informational experience to a user, via following methods:
With “search with awareness of language and region”, our system employs methods that discern the language and region of a user query, and serve search results, advertisements, and other contents on our web site, that target the language and region. Further, our system as a search engine passes this information to destination web sites that the user visits upon leaving our search engine.

Various aspects of the inventive subject matter can also be perceived as objects and advantages, each of which can be implemented independently of the others, and each of which should be viewed as desirable but not essential.
In one aspect, embodiments can focus on awareness of a user query's language and region, and in that manner they can try to serve records whose target language and region matches the language and region of the user query.
In another aspect, one can create from a large database, such as billions of pages crawled from the Web, a smaller database that is focused on a given area such as an industry or perhaps a sector. Such a smaller database is by itself useful in serving certain search needs when applied the current Web search technology.
In another aspect, one can create a parameterized database from records such as web pages that are not parameterized. Once such a database is created, user input generally similar to those submitted to relational databases can be used in finding records, thus serving search needs.
In another aspect, one can apply specific area knowledge to free-text queries, so that a query is segmented into piece, each piece recognized as belonging to a type, and rules applied to pieces information individually and collectively. The result is then matched to a parameterized database using a matching and ranking mechanism that performs Proximity Search on multi-dimensions so as to achieve matching and ranking effectiveness that is impossible with the start-of-the-art search technology.
In another aspect, one can employ means such as automatically generated company summaries, query-dependent Request for Quotes, and others, to facilitate a searcher's need of deciding on which service providers to contact and how.
In yet another aspect, one can provide searchers around the world to get search results, advertisements, and contents of our web site, that match the language and region discemable in the searcher's query.
Viewed from yet another angle, one set of inventions addresses industry knowledge.
An industry expert would base recommendations upon extensive industry knowledge; what companies offer what services, which ones are the most reputable, cost-effective, reliable, and so forth. This all accomplished by the current inventions.
The system aggregates web information according to industries and sectors. This helps focus search results on commercially relevant information.
The system consolidates information for vendors in the industry or sector. This saves enormous time in finding capabilities, pricing, contacts, and other needed information. Currently, important information is either spread out over numerous web pages, or is not available on the web at all.
Vendor information is parameterized and normalized so that users can readily compare vendors.

Another set of inventions improve searching functionality:
Parameterization and normalization of data allows all data to be searched in multiple languages. Currently, web pages can be searched only in the language shown on the page.

Another set of inventions increase the value of click-throughs to advertisers:

Our inventions can turn a web search engine into a “specialized search engine in multiple areas”, by a way of partitioning its dataset. Such partitions can advantageously be along industry lines, or even along the lines of sectors within industries.

FIG. 1 depicts the scheme of claim 1 of this invention, which comprises methods that automatically discern a set of suspected geographical origins from which a user may have connected to a server, identify one or more languages of a user query, use the languages to evaluate applicability of each of the suspected origins, and use the origins and languages in retrieving records and displaying them to the user.

A geographic origin is the geographic location from which the user is connected to a server in the contemplated system. A geographic location can be a zip code (or generally a postal code), an airport code, a city, a non-political region such as “West Los Angeles” or “New England”, a city, a county, a metropolitan and micropolitan statistical areas as defined by the US Census (e.g., “Norfolk-Virginia Beach-Newport News”), a country, or a continent. In the discerning step, a smallest possible origin is sought out. For example, if “Los Angeles” can be discerning, it is preferred to “California”.

The discerning step utilizes information from user's connection, which could be via a Web browser, a cell phone, or a PDA, to name a few. The step also makes use of the user query, extracting information that is suggestive geographic locations. The result is a set of suspected origins to be further evaluated.

The use query is analyzed to find out the language, or sometimes languages, of the user query. The result is used in evaluating members of the set of suspected origins.

Once the origins and languages are determined, both help to guide retrieving of records. Records that match the origins and languages are preferred to those do not. When retrieved records contain at least two records each matching a different origin, with one embodiment, display is arranged so that records from two or more origins are concurrently displayed. Similarly, when retrieved records contain at least two records each matching a different language, with one embodiment, display is arranged so that records two or more languages are concurrently displayed.

Records are also partitioned so that different partitions are applied different functions in retrieving and displaying. For example, one partition of the records could comprise web pages from a company, and another partition could comprise advertisements in textual or rich media format from a same company.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 depicts the scheme of claim 1 of this invention, where a user connection and a user query are used in the following steps: (1) discerning suspected geographic origins of the user; (2) detecting user language; and (3) using the language or the languages to evaluate the suspected origins.

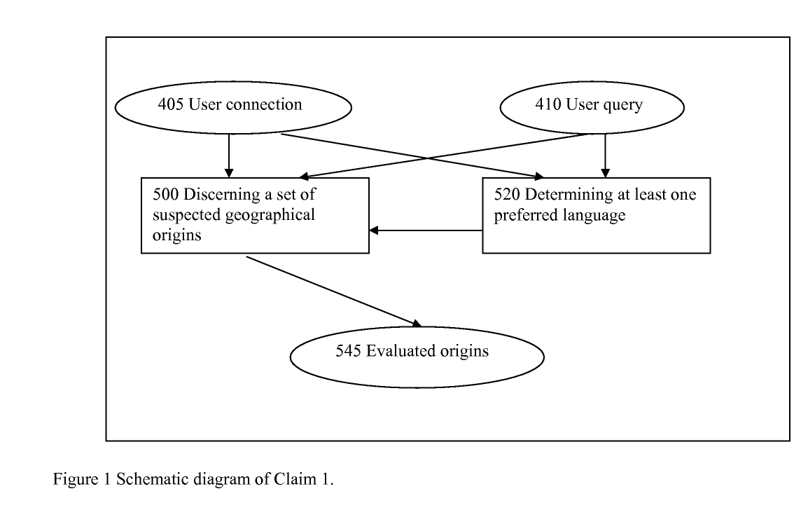

FIG. 2 shows prior art methods used by U.S. Pat. No. 6,623,529, David Lakritz, Sep. 23, 2003, in determining the language and country of a web site visitor, and using the determination in retrieving documents from country/language databases.

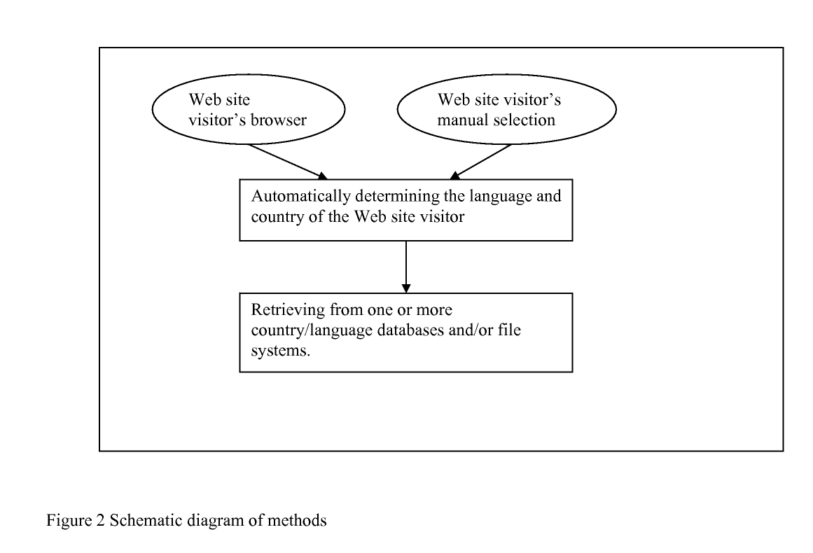

FIG. 3 shows prior art methods used by US2004/0194099 A1, Lamping et al., Sep. 30, 2004, in dynamically determining preferred languages from user queries as well as from preliminary search results, in order to sort final search results with one or more preferred languages.

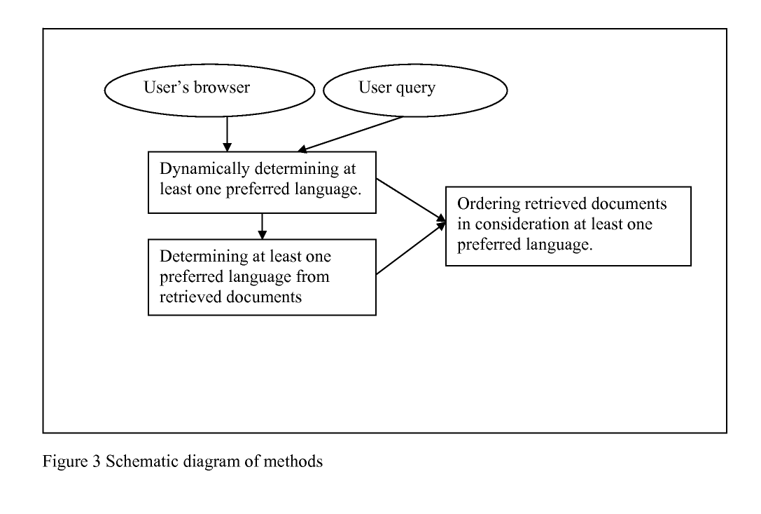

FIG. 4 shows prior art methods used by US 2004/0254932 A1, Gupta et al., Dec. 16, 2004, in dynamically determining preferred country from user queries as well as from preliminary search results, in order to sort final search results with one or more preferred country.

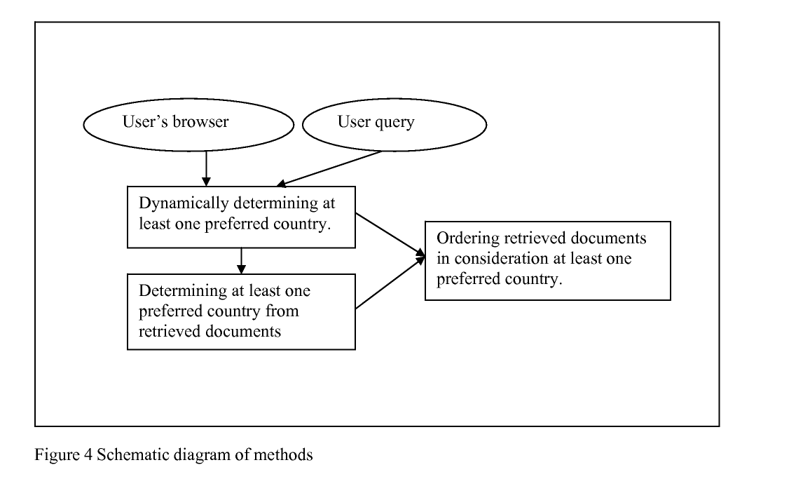

FIG. 5 shows prior art methods used by US2006/0106778 A1, Laura Baldwin, May 18, 2006, in determining a geographic location from a user query. (This prior art also disclosed their utilization of user's browser's information in the same determining step.)

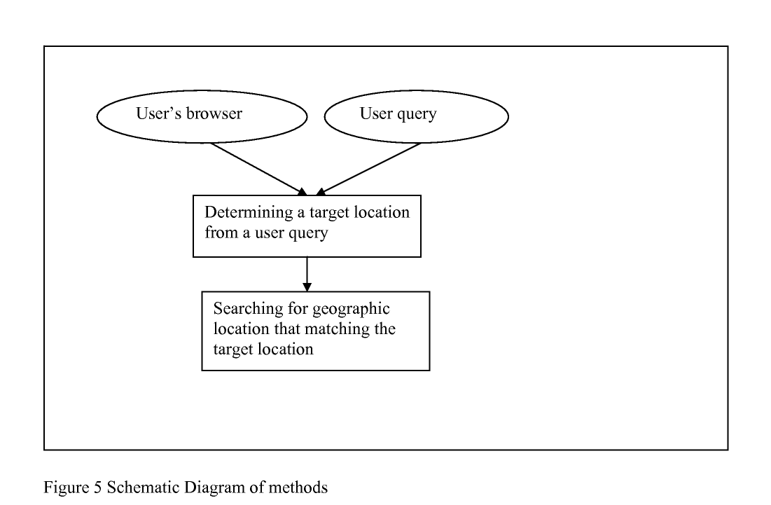

FIG. 6 depicts generally an embodiment of this invention, where a user connects to the system, submits a query, and the system retrieves and displays records.

FIG. 7 depicts the general steps of automatically discerning a set of suspected geographic origins of a user, using both the user's connection (e.g., a Web browser) and the user query.

FIG. 8 depicts the general steps of determining languages of the user, also using both the user's connection and the user query.

FIG. 9 depicts the general steps of using user languages in evaluating the goodness of individual members of the set of suspected origins.

FIG. 10 depicts the general steps in evaluating combinations of languages and locations.

### ADDITIONAL DESCRIPTION OF PARTICULAR ASPECTS

1. Searching Parameterized Data Using Natural Language Queries

In one set of embodiments, systems and methods facilitate free-text search queries for complex information by parameterizing a dataset from records. All suitable source records are contemplated, including for example, being web pages and product catalogues. Further, the dataset can be focused on a particular area, which could be an industry or perhaps a kind of consumer products.

A preferred class of embodiments includes methods for (a) automatically culling from web pages from the entire Web those web pages are considered as relevant to the focused area, and excluding as much as possible those pages not considered as relevant. The resultant database is by itself useful to the searcher when applied the current Web search technology; (b) creating a parameterized dataset from the culled records. Typically in the parameterized dataset, records are associated with entities such as companies. Further, parameterization methods are updated with changes in the industry, such as changes in terminologies, in rule, in classification of businesses; (c) taking in a user query that is composed of free text, such a user query is not unlike queries submitted to web search engines; and parameterize such a query (d) matching parameterized a query with records in parameterized dataset, ranks matched records, and displays them according to their rank.

With another embodiment, the system includes methods on (a) taking a relational database, typically a catalogue of products, or a database of companies, and transforming it into an intermediate format; (b) apply the step (b) in the above embodiment; (c) apply the step (c) in the above embodiment.

2. Iterative Dual Expansion for Creating Datasets of Both High Precision and High Recall

Given a “topic”, as in the common sense of the English word, it is difficult to create a dataset, namely a collection of records, such as web pages, that's of both high precision and high recall.

There are two existing extremes. (1) There are datasets of high precision but low recall. Think an on-line directory devoted to a topic.—Almost every record within the directory is relevant to the topic, thus the precision (of the dataset) is very high, approaching 100%. (2) There are also datasets that have high recall but very low precision. Think of the entire dataset of a web search engine (e.g., Google, Alexa). Almost all pages that are related to the topic is indeed in the dataset, thus high recall, but these pages are a tiny percentage of the entire dataset, thus the recall is very low.

Our method has as input two datasets, one is of high precision, but low recall, the other high recall but low precision. By applying our method, named as “Iterative Dual Expansion”, we grow a third dataset, which is the output, into a dataset that is of both high precision and high recall.

The techniques can also be applied when one of the input datasets are changed, thus the freshness of the output dataset can be assured.

The most important metrics of measuring the method is the resulting precision and recall of the dataset, compared to those that can be achieve by “conventional” means.

An additional metric is that of speediness. The amount of time that takes to create a dataset shall be “reasonable”, and we believe that it should be in weeks at most, when a reasonable amount of computation recourse (CPU time, memory and disk space) is available.

3. Creating Parameterized Data from Web Records

The methods start with records such as web pages and associate them according to entities such as companies. Mainly by extracting service provisions' information from a company's web pages, a company is recognized as of certain type, as determined by the kind of services the company provides.

Within an industry, the type of a company can be arranged in a hierarchical manner, called a type hierarchy. For example, “warehousing” can be divided into “public warehousing”, “private warehousing”, and others, and each of these “second-level” types, namely sub-sectors, can be further divided.

By applying industry knowledge, for each type, a hierarchy of fields is determined.

A company in general can belong to more than one type. Our methods recognize a company to the deepest possible levels on the type hierarchy.

Once a company's types are recognized, our methods fill the fields that correspond to its types. A field is filled when a value, which could be text or numbers, or others, is associated with the field.

There are several major steps:
1) First, recognizing those web pages that are most likely contain useful information, such as services, contact information, etc. Currently we make use of the URL string, as well as anchor text/hyper links.
2) The second step is for each paragraph on a page, recognize the service that it might be describing. To this end, for each recognition task, there is a list of best descriptors (typically they are keywords, phrases with certain positive or negative “weights”). The list is applied to a target paragraph, and a score is computed to indicate to what extent the paragraph is recognized
3) Third, associate each paragraph with one or more sub-sectors of an industry.
4) Fourth, associate the company with one or more sub-sectors of an industry.

4. Segmentation of and Deduction from Natural Language Queries

The Query Understanding mechanism takes in a query, typically in natural language, and tries to “understand” as much as possible what the query is about in the context of an industry. It first segments the query text into one or more pieces of information, each of which is recognized as a type of information. For example, in the context of logistics and transportation, a type could be cargo, service, location, or route.

A recognized piece of information is normalized so that equivalent information is associated with one form. Common jargons, abbreviations and acronyms are normalized.

For each one piece of information that is recognized, certain rules are applied, so as to deduct knowledge. For example, if the piece of information is the city of Los Angeles, after certain rules are applied, it is known that the city of Los Angeles is also a port, and that LAX is associated with the city of Los Angeles. If the airports are in different countries, customs will be required.

If there are multiple pieces of information, after the above rules are applied, another set of rules are applied to the relationship among the pieces of information, so that more knowledge is deducted. For example, given two pieces information, one, LAX, the airport code of the Los Angeles World Airport, and the other, JFK, the airport code of the one of New York City's airports, then within the context of logistics and transportation, the knowledge can be deducted that many companies provide air express services on this route.

The recognized pieces of information, the unrecognized portion of the user query, and knowledge deducted, are utilized in searching, as well as generating information that's helpful to the searcher.

Our method is able to understand queries in mixed languages (e.g. a query composed in both English and Chinese.)

5. Multi-Dimensional Proximity Search for Matching and Ranking

Proximity search on documents for a given query is at the core of current web search technology, which was popularized by Google founders' 1998 academic research paper. A document is typically a web page, which essentially is a one-dimensional list of word, and a query is also a one-dimensional list of words.

We have developed a method for Proximity search on documents that are expressed in multi-dimensions for a given query. The query is also essentially multi-dimensional. We call our method “Multi-dimensional Proximity Search”.

The necessity for the new method is exemplified by the search for services provided by companies. A service is described by many attributes, and therefore is inherently multi-dimensional, where each dimension is a chain of (attribute, value) pairs. Further, some attributes can be group together (such as those for contact information). Further, a company's information, which includes its services, its contact information, is inherently multi-dimensional. In expressing multi-dimensional information, the most efficient data structure is that of a tree.

Similarly, a query, originally in free text, once interpreted and transformed, is inherently multi-dimensional, and is most efficiently implemented in a tree data structure. For example, “break bulk from Shanghai to Cincinnati” in the context of logistics can be interpreted as break bulk service, with a route from China to the U.S., and further a route that can be broken down into an ocean route and a river route.

To match a tree-like query and a tree-like company data, a relatively sophisticated algorithm is needed. We have designed an algorithm that is optimal with a set of reasonable assumptions.

Within this context, what web search does can be described as “one-dimensional” matching, where the free-text query is a one-dimensional list of words, and each document is essentially a one-dimensional list of words.

The method is an enabling technique for performing search on combined structured and unstructured data. The essence of structure data is that they are expressed in (attribute, value) pairs. The lack of this essence makes a piece of data “unstructured”. For example, records in relational databases are considered as structured, while information contain in web pages are considered as unstructured. By attaching unstructured data as additional dimensions to the multi-dimensions of structured data, structured and unstructured data are combined. And our method of multi-dimensional proximity search enables search on combined structured and unstructured data.

Finally, the method applied to the computation of similarity between two entities.

Applying the NOT Logic

By applying rules from an industry, it could be known that certain results are impossible to be relevant to a user query. Such rules are called the “NOT” logic by us.

For example, the query “1000MT machine tools from China to Mexico” shall all but exclude any companies that offers only air freight services.

6. Search with Awareness of Language and Region

Over the last decades, English has emerged as the language of commerce, and Chinese has established as the other language to be reckoned with in commerce. However, there has not been a search engine that is devoted to severing this international market. Namely Google™Yahoo™/MSN™ do English search, and Baidu™ does Chinese search only. All engines do exact matching. The current situation is that a user searches on Google with a Chinese query might get back pages that are in mixed Chinese and English, and the advertisements are sometimes not in Chinese, which reduces the usefulness of the search results, as well as the effectiveness of the ads. Baidu does the same thing in a mirror image.

Our system performs search with awareness of language and region. It does at least the following:
5) filtering ads based on user query's language, (considering a company that has multiple ads)
   a) if a user query is entirely in Chinese, serve ads dubbed in Chinese
   b) if a user query is entirely in Chinese, server ads specifically targeting the Chinese audience
   c) do (a) and (b) for other languages
   d) Take into consideration the region of the user, namely the geographic location where the user has submitted the query. When this information is available, serve ads specifically targeted to the region.
6) serving web page contents based on user query's language
   a) On our engine's homepage, its results pages, etc., a web page is divided into multiple areas, and each area's content could be dependent on a user's language and/or region.
   b) The implementation could be in ajax or similar techniques
7) Normalize into meta information
   a) Normalize queries into (internal) meta information
   b) Identify and normalize records in our system's dataset. For each entity, there are two provisions: (a) if there is information for the entity is language- and region-specific, then it is matched with higher priority with the user query's language and region; (b) the system prepares translation for certain part of an entity's record, and the translated information is matched against the user query's language and region.
8) When a searcher is led by our system to a destination web site, pass the language ID, the region, and other similar information to the web site
   a) General web search engines do not do this right now;
   b) Some affiliate network web sites pass their own ID to a destination web site such as Amazon.com, but it does not appear that they pass language IDs or regions;
   c) Our system will pass this information to a destination web site, and the web site can make sure of this information in serving its contents, much like how our system serves ads and contents with awareness of a user's language and region.

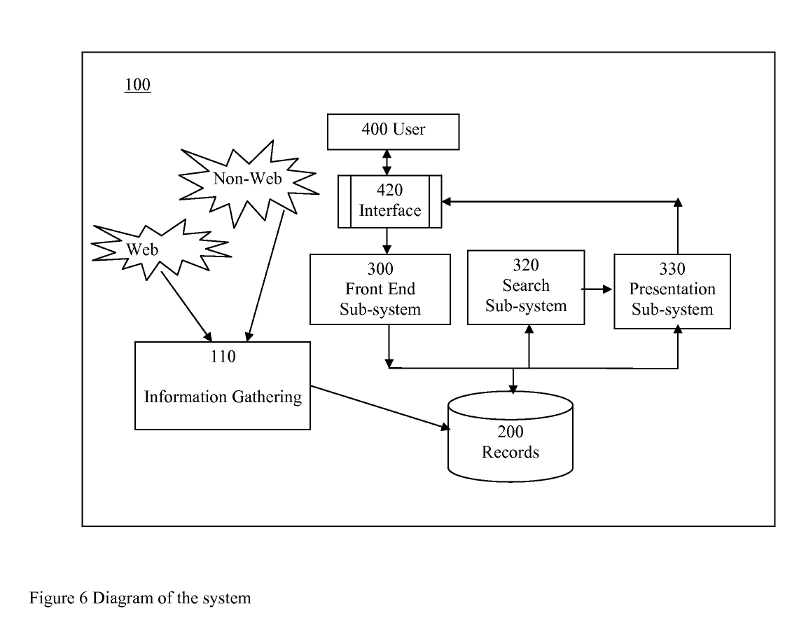

FIG. 6 depicts generally an embodiment 100, where a user 400 connects to the system through the Interface 420. Through 420, a user query is submitted to the Front End Sub-system 330, which provides the user query as well as other information, to the Search Sub-system 330, which finds matches among records stored on 200 Records Repository. The Presentation Sub-system 330 is provided with matching records as well as other information from 300 and 320, and display records on the Interface 420. Records on 200 have been processed from information gathered by 110 Information Gathering Sub-system from Web or non-Web sources before a user connects.

Regarding 200 Records Repository, a record is associated with a geographic location, including but not limited to a postal code, a district, a non-political region, a city, a county, a metropolitan and micropolitan statistical areas (for example, as defined by the US Census), a country, and a continent. For example, a post code could be “90210” or “310013”; a political district “Central, Hong Kong”; a city “Los Angeles” or “Hong Kong”; a county “Los Angeles County”; a non-political region “West Los Angeles” or “the Greater Los Angeles” or “the West Coast” or “New England”; a metropolitan and micropolitan statistical area “Norfolk-Virginia Beach-Newport News”; a country “United States of America”; a continent “North America”.

A record is also associated with at least one language. A language could be “English”, “American English”, “British English”, “Chinese”, “Cantonese”, “Chinese simplified”, “Chinese traditional”, or “Chinese Hong Kong”.

Further, a record comprises information in the form of text, or of rich media format (e.g. audio, video, image), or a combination.

Still further, a record could be a combination of other records. For example, a record labeled as “Record A” could be about a company's general introduction, and is combined from three records, “Record A1”, “Record A2”, “Record A3”, and “Record A4”, where “Record A1” is textual and associated with the geographical location “China mainland” and the language “Chinese simplified”, “Record A2” is textual and associated with the geographical location “California” and the language “US English”, “Record A3” is a video with Chinese dubbing and associated with “China mainland” and the language “Chinese simplified”, and “Record A4” is a video with English dubbing and associated with “California” and “US English”.

Still further, records on 200 Records Repository are partitioned. For example, one partition of the records could comprise web pages from a company, and another partition could comprise advertisements in textual or rich media format from a same company.

Through out the discussion below, it is intended that a method applied to one partition might not be the same for another partition.

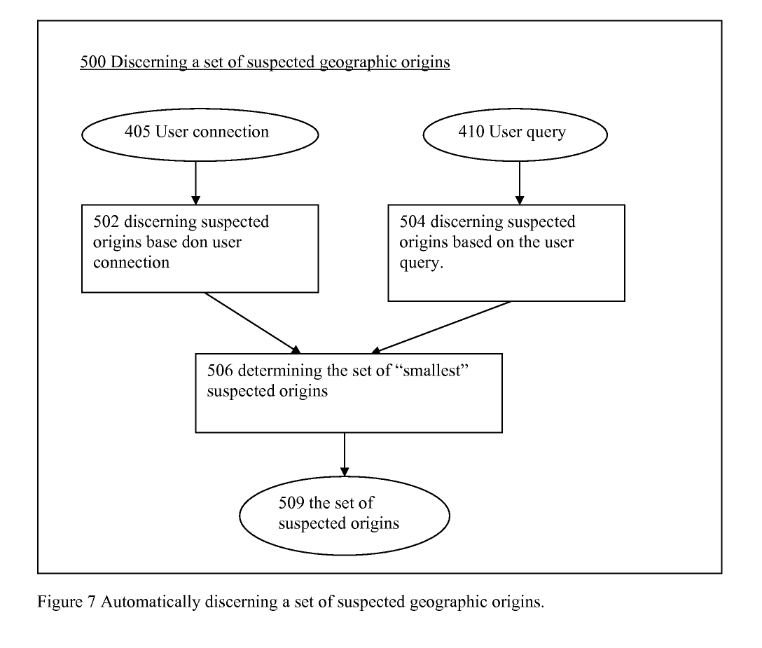

FIG. 7 depicts Step 500 of automatically discerning a set of suspected user origins, which generally comprises a user connection 405, a user query 410, step 502 discerning origins from the user connection, step 504 discerning origins from the user query, and step 506 deciding on a set of “smallest” suspected origins. A geographical origin is the geographical location from which the user connects to the server.

A user connection 405 preferably is from a computer (desktop, laptop, workstation, server, etc.), alternatively from a cell phone, or a PDA, or others. In prior art US 20040254932 A1, Gupta et al., Dec. 16, 2004, various such connections are disclosed in paragraph 0030.

In Step 502, different methods are applied to different connections, to name a few below.

(502.A) A client computer connecting using the HTTP protocol. Typically the client uses a web browser, which transmits various piece of information, as specified by the Common Gateway Interface protocol, including but not limited to (1) the client's Internet Protocol (IP) address which can be used via Reverse IP lookup in order to map to geographic locations. This is disclosed in both US2004/0194099 A1, Lamping et al., Sep. 30, 2004, paragraph 0081, and US2006/0106778 A1, Laura Baldwin, May 18, 2006, paragraph 0038; (2) the client's hostname, which can be mapped via Domain Name Resolution to geographic locations. This is also disclosed by the above two prior arts; and (3) with certain software such WebPlexer, country can be automatically determined, as disclosed in U.S. Pat. No. 6,623,529, David Lakritz, Sep. 23, 2003, section 3.4.1.

(502.B) A client providing a phone number. A cell phone client could provide this information. The phone number's country code, area code, central office code, as well as the other parts of the phone number, can all be used in mapping into geographic locations.

(502.C) A client providing GPS coordinates. GPS coordinates can be mapped into geographic locations.

In Step 504, the user query string is analyzed for information suggestive of geographical locations. Some of the methods are discussed below:

(504.A) Looking for a proper name for geographic locations such as “Los Angeles”, “Shanghai”, the Chinese equivalent of “Shanghai”, a location's nickname such as the “Big Apple”. This method is generally disclosed in US2006/0106778 A1, Laura Baldwin, May 18, 2006, paragraph 0040.

(504.B) Looking for information other than proper names suggestive of geographic locations. For one example, in the query “flying from LAX to JFK”, two geographic locations are present.

In Step 506, at least two sets of suspected origins are merged, and the goal is to find the set of “smallest” geographical locations, whose preferred definition is that the union of members covers the smallest possible geographical area. For example, given the following two sets: (i) {“United States”}, and (ii) {“California”, “Oregon”, “Arizona”}, the method finds the latter set. All suitable algorithms are contemplated, including but not limited to lookup tables, greedy search algorithms, and shortest path algorithms.

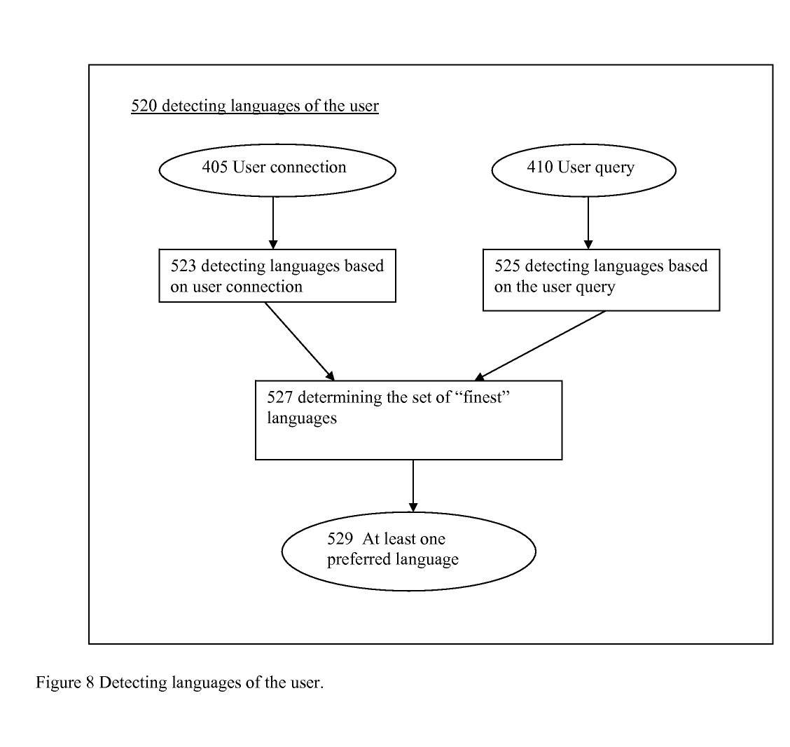

FIG. 8 depicts Step 520 of detecting languages the user uses, which generally comprises a user connection 405, a user query 410, step 523 of detecting languages from the user connection, step 525 of detecting languages from the user query, and step 527 of merging the previous detections into a set of languages.

In Step 523, different methods are applied to different connections, to name a few below.

(523.A) A client computer connecting using the HTTP protocal. A web browser transmits various piece of information, as specified by the Common Gateway Interface protocol, and additionally through request message header, including but not limited to (1) the language accepted by the client's web browser. This is disclosed in prior art U.S. Pat. No. 6,632,529, David Lakritz, Sep. 23, 203, section 3.3.4, as well as in US2004/0194099 A1, Lamping et al., Sep. 30, 2004, paragraph 0079 and 0080; and (2) the client's operating system (such as “Microsoft XP Chinese”). Such information can be mapped into geographic locations. For example, “Microsoft XP Chinese” could be mapped to languages of {“China simplified Mainland China”, “Chinese simplified Singapore”}.

(502.B) A client providing a phone number. A cell phone client could provide this information. The phone number's country code is readily mapped into at least one language. Sometimes the area code is readily mapped into at least one dialect (e.g., Cantonese in parts of China).

In Step 525 of detecting languages from the user query, some contemplated methods are listed below.

(525.A) Technology for language identification for a text string is well known, e.g., the Rosette Language Identifier software from Basis Technology, Inc.

(525.B) In the case of a user query string composed of at least two different languages, new method is developed by this invention, so that a query string is first segmented into different parts, and each part is further detected of its preferred languages.

In Step 527, at least two sets of languages are merged into one set. The goal is to find a set of “finest” languages. For example, given two sets, (i) {“English”, “Chinese”}; (ii) {“American English”, “Chinese”}, the former is found. All suitable algorithms are contemplated, including but not limited to lookup tables, greedy search algorithms, and shortest path algorithms.

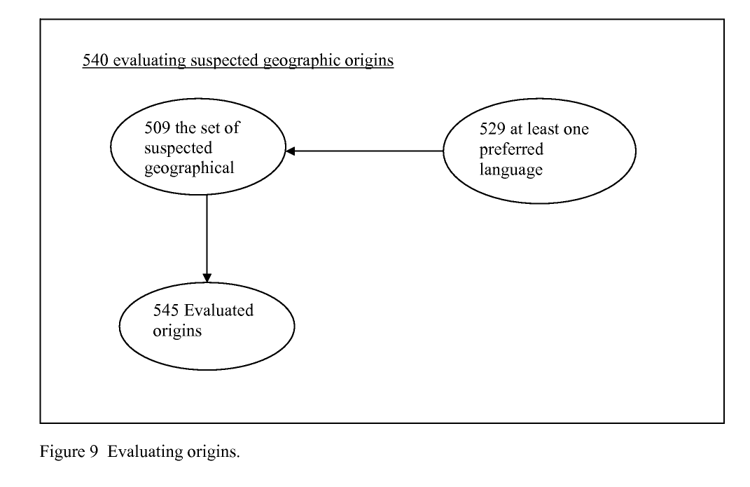

FIG. 9 depicts the general step in using the set of languages to modify the set of the suspected origins, and associating a confidence measure on every element in the set of origins. The result is the evaluated set of origins 545.

The system has knowledge on mapping from languages to geographical locations. One piece of knowledge could be (“Chinese simplified”=>{(“China mainland”, 0.9), (“Singapore”, 0.4), (“China Hong Kong”, 0.1)}. This piece knowledge states that the language “Chinese simplified” corresponds to three geographical locations each of which is associated with a confidence measure of 0.9, 0.4 or 0.1 respectively. Suppose there is a set of suspected geographical origins {“China mainland”, “China Hong Kong”, “Singapore”, “Taiwan”}, and a user query's language is identified as {“Chinese simplified”}, then applying the above piece of knowledge to the set of origins could lead to the removal of the element “Taiwan”, and the remaining three elements are associated with confidence measures partially derided from the piece of knowledge.

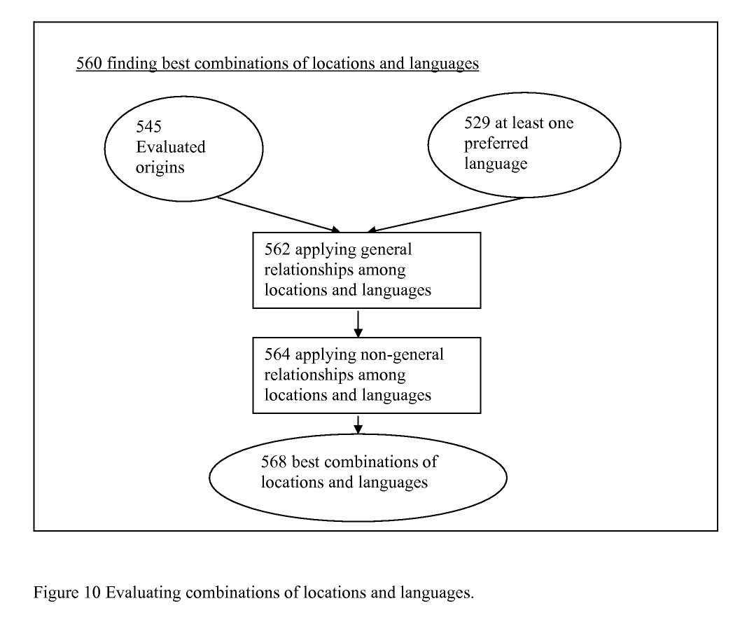

FIG. 10 depicts methods in finding the best combinations of locations and languages, which generally comprises the evaluated set of origins 545, the languages 509, Step 562 applying generally relationships among languages and locations, and Step 564 applying non-general relationships among languages and locations. The result is the best combinations 568.

In Step 562, general relationships among languages and locations are applies in order to evaluate combinations. Such relationships comprise commonly known language and location combinations that exist. For example, given the set of origins {“London”} and the languages {“US English”, “UK English”}, then the combination of (“London”, “UK English”) is evaluated as a preferred one to (“London”, “US English”). The system stores such relationships, with one embodiment in a lookup table.

In Step 564, non-general relationships among language and locations are applied. Some sets of such relationships are listed below.

(564.A) One set of such relationships are those of local nature. For example, regions such as Montreal have two prevailing languages, and this local relationship overrides the general relationship of (“Canada”, “English”).

(564.B) Another set of such relationships are those inheritably “conflicting”. For example, a user connects from Shanghai, using a browser on a Microsoft XP Chinese operating system, submitting a query in simplified Chinese that has “90024” in it. The suspected origins are thus {“Shanghai”, “90024”} (90024 is a zip code in Los Angeles), and the language {“Chinese simplified”}. Consider the relative goodness of the two combinations: (“90024”, “Chinese simplified”) and (“Shanghai”, Chinese simplified). The first combination might well be what the user is seeking (information relevant to the zip code, and in simplified Chinese), however, there is very little such information exits. The second combination might not be what the user is seeking, but there is a large amount of such information exists. Such relationships are accumulated through interviewing experts and by collecting statistics, and stored on the system. One embodiment is the storage is lookup tables, another embodiment probability rules.

Once the suspected origins, the languages, and the best combinations of the two, are derived, they are used in retrieving and displaying records.

As stated above, a record on 200 Record Repository has been associated with a geographic location and a language. The matching of a user's geographical origin and a record's geographical location is done at smallest geographical area possible. For example, if a set of origins is {“California”, “Arizona”}, and a location is {“Los Angeles”}, then the matching is “Los Angeles”.

At Search Sub-system 300, the matching of a query's language and a record's language is at the finest possible. For example, if a query's language is “Chinese”, and a record's language is “Chinese simplified”, then the matching is “Chinese simplified”. The Search Sub-system 300 retrieves those records whose geographical locations and languages match a user query with priority over those do not. Further, the best combinations 568 are applied in sorting the retrieved records. All suitable algorithms are contemplated, including but not limited to lookup tables, greedy search algorithms, and shortest path algorithms.

At Interface 420 where retrieved records are displayed, several methods are contemplated as below.

(420.A) If there are two combinations of location and language, display records in two areas, one for the first combination, and the other for the second combination. If there are more than two good combinations, records in the best two are displayed first.

(420.B) If combinations of locations and languages are not available, the following methods are contemplated:

(420.B.1) If a user query has two suspected origins, our system displays records in two areas, one for the first origin, and two for the second origin. If there are more than two origins, records in the two with highest confidence measures are displayed first. Preferably records are displayed in two areas.

(420.B.2) If a user query has two suspected languages, our system displays records in two areas, one for the first language, and two for the second language. If there are more than two languages, records in the two with finest languages are displayed first. Preferably records are displayed in two areas.

Other aspects of the inventive subject matter that are not being prosecuted at the outset include the following:
A method of facilitating a search by a user, comprising: identifying a collection of pages for a sector of an industry, using 1^{st} keyword list for the industry, and using 2^{nd} keyword list for the sector; identifying provider entities referenced in the collection; deriving entity-related information from the collection; possibly completing missing information from other sources; normalizing the information; parameterizing the information according to fields of interest, where different sectors have at least one different field of interest (service, region, contact, title, etc) creating records that associate individual ones of the pages in the collection with individual ones of the providers, and corresponding portions of the information; and associating multiple pages of the collection with a given company as a function of a common domain name. Within that concept the pages could be from the Web; and the pages could be information collected from advertisers.
A method of calculating an extent of matching between first and second ordered lists of words, compromising: finding occurrences of words from the first list within the second list; finding consecutive sequences of such occurrences in the second list; and performing a comparison step using at least a specific one of the sequences. Within that concept the comparison step could comprise determining whether the specific sequence is found in the first list; the comparison step could comprise determining whether the specific sequence is a permutation of a portion of the first list; the comparison step could comprise (a) determining whether the portion includes words that are absent from the specific sequence; and/or (b) determining whether the specific sequence is a permutation of words from the first list plus words that are not on the first list; and/or (c) determining whether the specific sequence is a permutation of a portion of the first list. The concept could additionally involve (a) performing a second comparison using the specific one of the sequences, and assigning a measure to each of the comparisons, or (b) assessing the extent of matching as a function of the measures.
A method calculating an extent of matching between two records, each of the records expressed as a chain of attribute/value pairs, where an attribute comprises an ordered list of words, and a value comprises an ordered list of words, comprising: finding the occurrences of words of the first record within the second record; applying a proximity search to measure the extent of matching between an attribute from the first record and an attribute from the second record; defining any extent of matching between an attribute from the first record with any attribute from the second as an “occurrence” of the attribute from the first record in the second record; applying the proximity search to measure the extent of matching between a value from the first record and a value from the second record; defining any extent of matching between a value from the first record with any value from the second as an “occurrence” of the value from the first record in the second record; and applying the proximity search, using these occurrences as input, to measure the extent of the matching between these two records. Within that concept, at least one of the records could have a second chain.
A method of providing records to a user, comprising: automatically discerning a set of suspected geographical origins from which the user may have connected to a server; identifying a first language of a term submitted in a query by the user; and using the first language to evaluate applicability of an individual member of the set of suspected origins to the user. Within that concept, at least one of the origins could be a non-political region, a metropolitan or micropolitan statistical area, a postal code, an airport codes. Also, the set of suspected origins could include a smallest member, where the individual member is the smallest member. In other aspects, the concept could further comprise (a) using a second term from the query to assist in evaluating the applicability of the individual member; (b) preferentially serving information to the user as a function of at least one of the individual member and the first language; (c) concurrently displaying to the user at least a portion of the information in both the individual member and another member of the set of suspected origins; (d) concurrently displaying to the user at least a portion of the information in both the first language and another language; and/or (e) providing a display to the user that includes first and second areas, each of which contains a portion of the information. The information could be derived from a plurality of records that are selected at least in part as a second function of at least one of the individual member and the first language. Still further, at least some of the plurality of records contain data in a rich content format.

Thus, specific embodiments and applications of searching and billing improvements have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1-10. (canceled)

11. A method of providing information to a user with respect to an industry, comprising:
abstracting web pages into a parameterized and at least partially normalized database using industry knowledge;
allowing the user to conduct keyword searches against the database to identify suitable providers for a given project;
determining additional information deemed to be helpful in selecting a provider;
seeking the additional information from the user; and
providing a list of the suitable providers to the user.

12. The method of claim 11, further comprising selecting at least some of the web pages to be abstracted at least in part using a keyword search.

13. The method of claim 11, further comprising associating records within the database with first and second sectors of an industry.

14. The method of claim 11, wherein at least some of the additional information has particular significance for an industry.

15. The method of claim 11, wherein at least some of the additional information has particular significance for the first sector.

16. The method of claim 11, wherein the industry is selected from the group consisting of health care, travel, real estate, and entertainment.

17. The method of claim 16, wherein the industry comprises residential real estate.

18. A method of modifying a query, comprising applying industry-related lists against the query to derive related additional terms other than terms derived from stemming.

19. A method of facilitating a search, comprising:
identifying by human inspection a first dataset comprising a collection of web pages that is known to be an industry;
identifying by human inspection a list of keywords for the industry;
identifying a second dataset that is at least partially a superset of the first dataset;
iteratively expanding the first dataset by copying pages from the second dataset;
updating the list of keywords by adding a new keyword;
modifying a quality measure of at least one of the keywords; and
establishing a stop threshold.

20. The method of claim 19, wherein the second dataset comprises at least 50% of public access web pages available on the Internet.

21. The method of claim 19, wherein the second dataset comprises at least one billion records.

22. The method of claim 19, wherein the step of establishing a stop threshold comprises stopping the iterations after the copied pages have a low score as measured by keywords on the keyword list.
